(19) United States
(12) Patent Application Publication
(10) Pub. No.: US 2008/0104545 A1
(43) Pub. Date: May 1, 2008

(54) Multimedia viewing enclosure with predetermined content

(76) Inventors: David James Palmieri, Millstone, NJ (US); Salvatore Judo Maiorino, Miami Beach, FL (US); James Palmieri, Staten Island, NY (US); Jeffrey Greene, Colta Neck, NJ (US)

Correspondence Address: Salvatore J. Maiorino, Esq;Sun Trust International Center, STE 2920, One SE 3rd Avenue, Miami, FL, 33139, US

(21) Appl. No.: 11/981,101

(22) Filed: Oct. 31, 2007

Related U.S. Application Data
(60) Provisional application No. 60/855,479, filed on Oct. 31, 2006.

(51) Int. Cl. G06F 3/048; G06Q 20/00

(52) U.S. Cl. 715/847; 705/39

(57) ABSTRACT

A multimedia viewing booth is disclosed that includes a computer terminal with a touchscreen, a CPU, a payment processor and a digital media I/O unit. The touchscreen displays a certain number of icons with each icon linked to predetermined content. A first portion of the icons is linked to a first type of content and a second portion is linked to a second type of content. The touchscreen displays a GUI with a selection menu for a user to select content, inform the user whether payment is needed, what content is available, how much time for viewing is available, display the selected content, and to interact with the user. The CPU manages the system to accept payment via the payment processor, control the touchscreen, process user interaction and function accordingly, access and activate content display, manages content purchases and downloads via the I/O unit, and interfaces with a communication link to access content.

### CROSS-REFERENCE TO RELATED APPLICATION

This application claims priority from U.S. Provisional Patent Application No. 60/855,479, entitled “METHOD AND SYSTEM FOR PROVIDING A PREDETERMINED PORTION OF PRE-SELECTED CONTENT FOR PRIVATE ACCESS,” filed Oct. 31, 2006.

### BACKGROUND

Internet cafes provide Internet access to patrons via computer terminals at separate desks or cubicles. Some cafes provide wireless fidelity (wi-fi) networks so a patron can use his own portable computer terminal to access the Internet via the wi-fi network.

These prior art set-ups provide little to no privacy for patrons and create an environment ripe for identity theft and the wrongful obtaining of an individual's access information for various web-based services such as online banking and e-mail accounts.

Adult-oriented-multimedia establishments (AOMEs) offer adult material for viewing on the premises in an enclosed booth and are often restricted in the way they operate. In general, the First Amendment allows these adult-establishments to operate, but local governments are making it harder and harder for these establishments to operate at a profit by enacting unfavorable laws that effectively put them out of business.

For example, under certain laws, AOMEs are required to provide no more than a certain maximum percentage of adult-oriented material, if such material is available. These establishments are coming under increased scrutiny and criticism, creating a severe erosion of the First Amendment right to free speech.

Adult-oriented-multimedia establishments (AOMEs) have tried continually to stay in business without success. Most cannot afford the costs of relocating and are forced to shut down. Those that can relocate are forced to move to an undesirable area, ultimately causing the business's demise.

### SUMMARY OF THE INVENTION

A multimedia viewing booth is disclosed that includes a computer terminal with a touchscreen, a CPU, a payment processor and a digital media I/O unit. The touchscreen displays a certain number of icons with each icon linked to predetermined content. A first portion of the icons is linked to a first type of content and a second portion is linked to a second type of content. The touchscreen displays a GUI with a selection menu for a user to select content, inform the user whether payment is needed, what content is available, how much time for viewing is available, display the selected content, and to interact with the user. The CPU manages the system to accept payment via the payment processor, control the touchscreen, process user interaction and function accordingly, access and activate content display, manages content purchases and downloads via the I/O unit, and interfaces with a communication link to access content.

In further detail, a display booth comprises an input device; a display; a microprocessor; memory operably connected to the microprocessor; a payment processor operably connected to the microprocessor, the payment processor configured to accept payment and inform the processor of the payment accepted; a program residing on the memory and executable by the microprocessor to: generate a graphical user interface (GUI) on the display with a specific number of icons; link a first portion of the icons to a first content type; link a second portion of the icons to a second content type; accept a selection of one of the icons; access content corresponding to the selection; and display the content for the time.

The invention further comprises computer executable process steps operable when executed to: generate a graphical user interface (GUI) on with a specific number of icons; link a first portion of the icons to a first content type; link a second portion of the icons to a second content type; accept a selection of one of the icons; access content corresponding to the selection; display the content for the time.

### BRIEF DESCRIPTION OF THE DRAWINGS

FIG. 1 depicts a multimedia viewing system according to a preferred embodiment of the present invention;

FIG. 2 shows a flowchart for software according to a preferred embodiment of the present invention;

FIG. 3 shows the flowchart of FIG. 2 with added functionality according to an alternative embodiment of the present invention; and,

FIG. 4 shows a viewing booth according to a preferred embodiment of the present invention.

### DETAILED DESCRIPTION

Typical AOMEs use a number of VCRs or DVD players connected over a network to a number of booths. In each booth is a monitor, or display, where a user can select from a number of channels. Each channel usually corresponds to a particular VCR or DVD player. Operating in this way brings the establishment within the scope of anti-pornography laws, leaving them with no alternative but to shut down if they are not located within the area zoned for such activity.

A system according to a preferred embodiment of the present invention creates a way to exercise the First Amendment right to view content one would normally be able to view at home, in a hotel room, or in any other private forum, in a public setting. The present invention enables the same access to Internet-based content enjoyed in one's home in a commercial setting.

In accordance with a preferred embodiment of the present invention, a viewing booth is enclosed to provide total privacy and includes a terminal for viewing multimedia content. The enclosure has an entry and exit point with opening and closing means for ingress, use of the terminal, and egress. The terminal comprises a touchscreen display and a payment processor, both operably connected to a central processing unit (CPU). Preferably, the display further comprises a graphical user interface (GUI) that includes a predetermined number of links, or graphical buttons also known as icons. The buttons are activated by touching the display on the area over the button itself, like an ordinary touch screen. Each button is linked to a certain predetermined data location that may include a local server, a remote server residing on a private communication network, or a remote website address residing on the Internet.

A first portion of the links connects with a first, particular class of websites categorized by content, such as adult-oriented content. A second portion connects with a second, particular class of websites different from the first. Following the previous example, the second portion would connect with non-adult-oriented websites. When a button is activated by touch, the corresponding website is contacted and its content shown on the display.

In accordance with further aspects of a preferred embodiment, the booth includes a payment processor, such as a coin slot, paper currency intake or a card swipe. These payment processors are well-known and widely used on vending machines. They accept payment, determine its amount and provide the CPU with the information necessary to determine how much payment is required and the amount that has been paid.

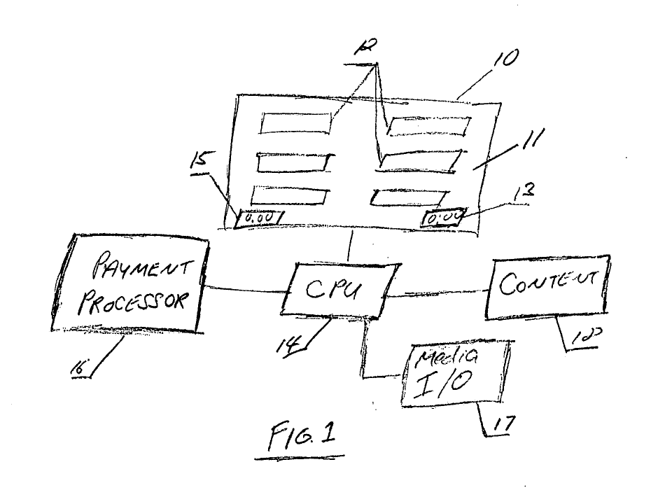

FIG. 1 shows a multimedia content viewing system according to a preferred embodiment of the present invention. A touch screen 10 acts as a display for multimedia content and as an input/output device to accept user selections for predetermined content and communicate with the user via text displays and graphical icons. Initially, the screen 10 presents a graphical user interface (GUI) 11 with a number of icons, or virtual buttons 12. In addition, graphical windows are provided to display the amount of payment made or required 15 and the time remaining 13. The GUI 11, with its individual elements may be referred to as a start menu, or a selection menu.

A payment processor 16 may include a coin slot, paper currency intake, a card swipe, or any combination thereof. The payment processor 16 may include any of those commonly used in vending machines, which are well-known.

A central processing unit (CPU) 14 includes memory that is operably connected to a microprocessor, as is well-known in the field of computer science. The memory has software stored thereon configured to verify payment, display the GUI 11, accept selection of a button 12, display its corresponding content for a predetermined amount of time, inform the user how much time remains and when the time is about to run out, request additional payment, and repeat the above process until the user chooses to end it, as an example. It should be noted that the program can be modified to include any kind of software functionality.

After payment is made, the CPU 14 allows the user to select a button 12 by touch. Each button 12 corresponds to certain, predetermined content, accessed via a link. The CPU waits for and accepts a button selection, determines its specific link, and displays the predetermined content on the screen 10.

The content 18 may be stored on a local server, a remote server, a website, or a mass data storage device. For example, the CPU 14 can be connected to a local (on-premises) or remote (off-premises) server via a communication network. The remote server includes those residing on the Internet that can be accessed via a website address. A mass storage device includes a series of hard drives on which the content is stored.

Optionally, a media input/output (I/O) unit 17 may be included to enable data exchange, content downloads and purchases. For example, a number of connections (not shown) may be disposed on a front surface of the unit 17, available to the user, to provide connectivity with a digital media storage device. The connections could include a Universal Serial Bus (USB) port, an IEEE 1394 Firewire port, and a universal media reader that typically includes slots to accept micro drives and flash memory units, as an example. The unit 17 could also include an optical drive that records content to an optical disc, like a CD or DVD.

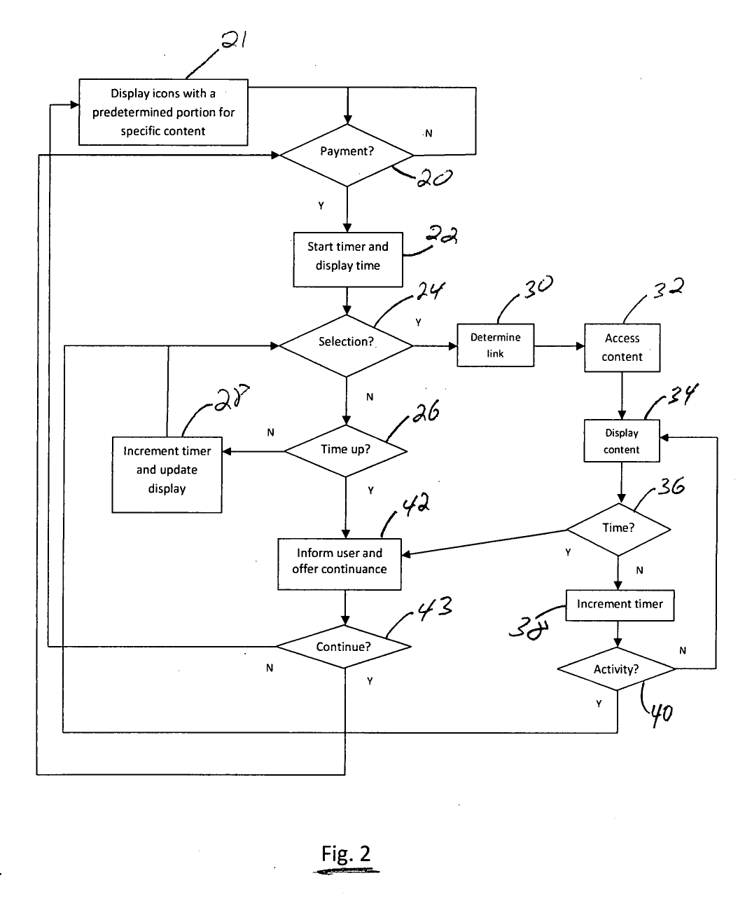

FIG. 2 shows an exemplary flowchart for a software program residing on the CPU 14. The program first displays the GUI 11 (step 21) and waits for payment to be made (step 20). The payment processor 16 sends data indicating that payment has been made and its amount when currency is inserted into the processor 16. If no payment is made, the program continues to loop (step 20) until a signal is received from the payment processor 16 indicating that a payment has been made, at which point a timer is started and displayed (step 22). The amount of time set for the timer is determined by the amount of payment rendered.

Alternatively, the system can first display payment and time options on the selection menu 11. For example, $10.00 for ten minutes, $15.00 for twenty minutes and so on. In this configuration, when a time and corresponding amount are selected, the CPU 14 waits for an indication from the payment processor 16 that the required payment has been made. At this point, the program would display the selection menu 11 (step 21) and start the timer (step 22).

After the timer is started and displayed (step 22), the program waits for a selection to be made (step 24) from the buttons 12 on the screen 10. If a selection is not made (step 24), the timer is checked to determine if the pre-paid amount of time has expired (step 26). If it has not expired, the time is incremented and the display updated with the new time remaining (step 28) and the program loops back to waiting for a selection (step 24). The program will continue this loop (steps 24, 26 and 28) until a selection is made or the pre-paid time has expired. Once the time expires (step 26), the user is informed via a message on the display and the user is offered a chance to continue by displaying an icon for “Yes” and an icon for “No” on the display 10 (step 42). If the user wishes to continue (step 43), the program then returns to the process of waiting for payment (step 20). If not (step 43), the program returns to displaying the start menu (step 21).

If, however, a selection is made before the timer is up (step 24), its corresponding link is determined (step 30), the associated content is accessed (step 32), and then displayed (step 34) on the screen 10. Then, the time remaining is determined (step 36) and if not expired, the timer is incremented and updated (step 38) and the system checks whether there has been any user activity (step 40). At anytime while the content is being displayed, the user can interrupt the program and make a new selection. If the user does so, and there is some activity (step 40), the program returns to step 24 to determine whether a new selection has been made. As before, the program will loop from step 24 to 26 to 28 and then back to step 24 until a selection is made or the time runs out.

If the display is not interrupted (step 40), the content is displayed continually until either the time runs out or the user stops the process (steps 34, 36, 38 and 40). Once the time runs out (step 36), the user is notified and given the chance to continue for more money (step 42). If the user does not want to continue, the program ends and returns to the selection menu (step 21). If, however, the user chooses to continue (step 43), the system waits for further payment (step 20).

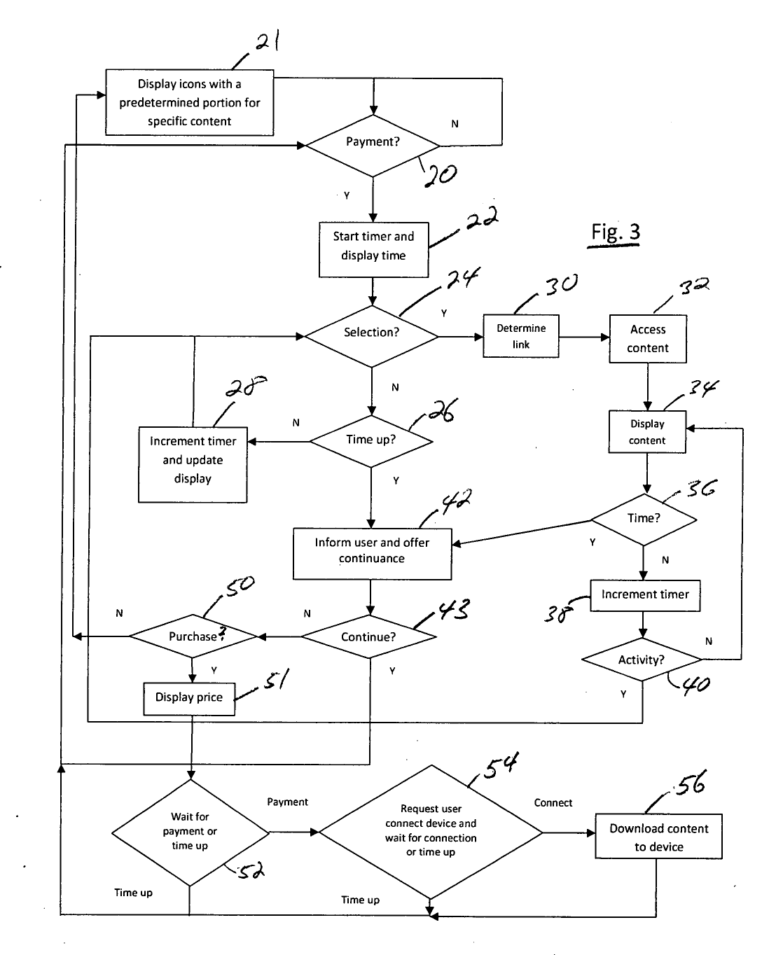

In accordance with alternative embodiments, the user may also be offered the chance to purchase content. FIG. 3 shows the flowchart of FIG. 2 with this added functionality. If the user does not decide to continue after the timer is up (step 43), the option to purchase the content is offered (step 50). If declined, the program returns to the selection menu (step 21).

If, however, the user chooses to purchase the content (step 50), the system displays the purchase price (step 51) and waits for payment within a pre-set time limit (step 52). If the time limit runs out before payment is made, the program returns to the selection menu (step 52).

If payment is made within the allotted time (step 52), the program requests the user to connect a storage medium to the I/O unit within a pre-set time limit (step 54). If the time limit runs out, the program will return to the selection menu (step 54). Although not shown, if the user has made some payment but did not receive the content because the time ran out before full payment was made or the digital media was not connected, a refund may be issued or a credit applied for other content to be selected by the user. When the program checks to see if payment is made (step 20), the credit will be recognized as payment.

If a device is connected within the pre-set time limit (step 54), the content is downloaded to the device (step 56) and when completed, the selection menu displayed (step 21). The download includes any writing operation by the CPU 14 onto the user's medium.

In accordance with preferred embodiments of the present invention, the screen 10, payment processor 16, I/O unit 17 and CPU 14 are housed in a private, stand-alone unit akin to a booth to provide a private, enclosed space to view the selected content.

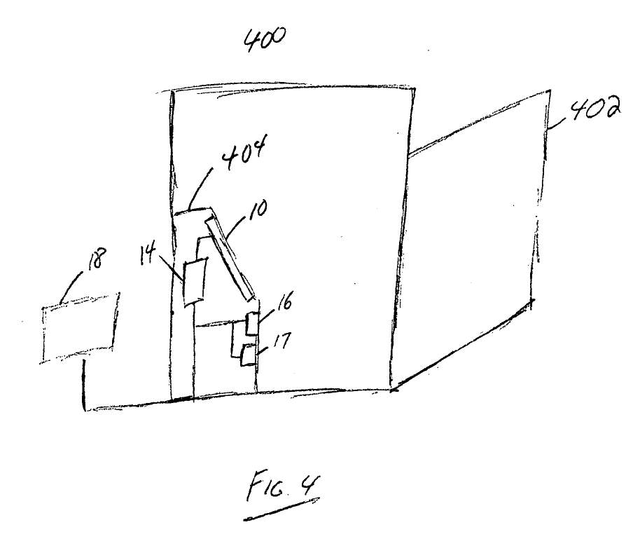

FIG. 4 shows a viewing booth according to a preferred embodiment of the present invention. An enclosure 400 has a door 402 for ingress and egress. The screen 10, payment processor 16, I/O unit 17 and CPU 14 are housed in a terminal enclosure. The content 18 is stored outside the terminal and communicates with the CPU 14 via a communication link. The enclosure 400 includes four walls interconnected to form a private booth. A floor and ceiling are not necessary since the walls may be installed between a pre-existing floor and ceiling. The enclosure 400, however, may include both a floor and a ceiling creating a complete stand-alone unit (not shown).

In accordance with further alternative embodiments of the present invention, a user may store all of their access information for websites and web services such as e-mail, online banking, shopping, travel sites, networking sites and online communities on a smart card or other kind of digital storage media. This personal online access information stored on digital media acts like an access key for a viewing booth according to preferred embodiments of the present invention.

The access key (the storage media with the personal access information stored thereon) may be inserted into the I/O unit 17 and allow the terminal to be used like an ordinary computer to access the Web. The touchscreen 10 may display a customized GUI configured by the user and stored on the access key, with a keyboard for typing if needed.

The customized GUI would include buttons linked to sites of the user's choice. The CPU accesses the personal information on the access key to log into the sites when the user selects a certain button on the GUI, as explained above, so that the user does not have to enter any information and can access all his personal web-based data quickly and easily without the need for a portable computer. The user can access his online information and download anything he may need onto the access key via the I/O unit 17.

In accordance with further aspects of preferred embodiments according to the present invention, when content is accessed via a member-only website, the owner of a viewing booth may contract with the member-only website to allow his patrons access to the member-only site without the patron actually having to be a member. This way, the patron is not required to purchase a full membership to access a member-only site.

In this case, the booth owner would have unlimited access to the member-only web content from any number of booths, allowing multiple viewers and simultaneous access under one membership without the end user having to become a member.

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A display booth comprising:
an input device;
a display;
a microprocessor;
memory operably connected to the microprocessor;
a payment processor operably connected to the microprocessor, the payment processor configured to accept payment and inform the processor of the payment accepted;
a program residing on the memory and executable by the microprocessor to:
generate a graphical user interface (GUI) on the display with a specific number of icons;
link a first portion of the icons to a first content type;
link a second portion of the icons to a second content type;
accept a selection of one of the icons;
access content corresponding to the selection;
display the content for the time.

2. Computer executable process steps operable when executed to:
generate a graphical user interface (GUI) on with a specific number of icons;
link a first portion of the icons to a first content type;
link a second portion of the icons to a second content type;
accept a selection of one of the icons;
access content corresponding to the selection; and,
display the content for the time.
